(19) United States
(12) Patent Application Publication
(10) Pub. No.: US 2026/0299778 A1
(43) Pub. Date: Oct. 1, 2026

(54) CUSTOM DATA OBJECT SELECTION AND RESOURCE FOOTPRINT ANALYSIS IN DATA MANAGEMENT SYSTEMS

(71) Applicant: SAP SE, Walldorf (DE)

(72) Inventors: Venu Krishna Murthy, Bangalore (IN); Claudia Semmler, Speyer (DE); Revathi M P, Bangalore (IN); Balaji Govindan, Bangalore (IN); Arvinda RV, Bangalore (IN); Sudhanva Laxminarayan, Bangalore (IN); Lavanya Bandla, Bangalore (IN); Liya Ajayan, Kochi (IN); Guru Venkata Rangesh L, Bangalore (IN); Axel Herbst, Eppingen (DE)

(73) Assignee: SAP SE, Walldorf (DE)

(21) Appl. No.: 19/091,702

(22) Filed: Mar. 26, 2025

(51) Int. Cl. G06F 3/06

(52) U.S. Cl. CPC G06F 3/0605; G06F 3/0649; G06F 3/0668

(57) ABSTRACT

Disclosed techniques facilitate the analysis of computing resource usage by data management objects, such as information lifecycle management objects. A selection of one or more data management objects is received, where each object abstracts underlying data storage entities, such as database tables or views. The selection may be based on user input specifying search terms, including business area identifiers, or direct object selection. The system identifies storage entities associated with the selected objects and determines a resource use footprint by obtaining memory usage data. When available, snapshot data is retrieved; otherwise, real-time computation is performed based on record count and storage allocation statistics. A user interface displays resource use data and enables user-specified adjustments to object residence time or allocated computing resources. Adjustments may trigger migration of data from memory to persistent storage or modification of storage parameters to optimize data residence and resource allocation.

### FIELD

This disclosure relates generally to data management and storage optimization. More specifically, it pertains to the selection, processing, and analysis of data objects for resource usage evaluation, such as memory usage evaluation, and storage policy adjustments, including but not limited to retrieval-based workflows, dynamic footprint calculations, and residence-aware processing.

### BACKGROUND

In modern enterprise computing environments, data growth presents ongoing challenges for storage management, system performance, and compliance. Large-scale business applications generate vast amounts of data that are maintained for operational use, reporting, and regulatory requirements. However, retaining all data in active memory can strain system resources, increase infrastructure costs, and degrade processing efficiency.

To address these issues, information lifecycle management (ILM) techniques provide structured approaches to handling data archiving and deletion. Such techniques typically involve categorizing data based on business relevance, aging criteria, and regulatory constraints, allowing organizations to migrate less frequently accessed data to lower-cost storage or remove it altogether when no longer needed, such as to comply with data privacy regulations.

Enterprise software platforms often include tools that assist administrators in identifying high-impact areas for data reduction. These tools may analyze database structures, track historical growth patterns, and estimate potential storage savings from archiving actions. While such capabilities can improve data management strategies, they often rely on predefined configurations and static reporting mechanisms that may not fully align with evolving business needs. As a result, organizations may struggle to obtain precise, actionable insights into their data footprint, leading to inefficiencies in storage allocation, compliance planning, and overall system performance. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed techniques facilitate the analysis of computing resource usage by data management objects, such as information lifecycle management objects. A selection of one or more data management objects is received, where each object abstracts underlying data storage entities, such as database tables or views. The selection may be based on user input specifying search terms, including business area identifiers, or direct object selection. The system identifies storage entities associated with the selected objects and determines a resource use footprint by obtaining memory usage data. When available, snapshot data is retrieved; otherwise, real-time computation is performed based on record count and storage allocation statistics. A user interface displays resource use data and enables user-specified adjustments to object residence time or allocated computing resources. Adjustments may trigger migration of data from memory to persistent storage or modification of storage parameters to optimize data residence and resource allocation.

In one aspect, the present disclosure provides a process for analyzing computer resource usage for selected data management objects. A selection of one or more data management objects is received for analysis, resulting in one or more selected data management objects. These selected data management objects are associated with one or more data storage entities that store data corresponding to the selected data management objects. The selection includes at least one of a direct selection of one or more data management objects by a user or user input specifying one or more search terms, where the search terms are used to identify one or more data management objects.

Following selection, the one or more data storage entities corresponding to the one or more selected data management objects are identified to provide one or more identified data storage entities. A computer resource use footprint is determined for the one or more selected data management objects by obtaining memory usage data for the one or more identified data storage entities. Obtaining memory usage data includes one or more of retrieving memory usage data from a snapshot when valid snapshot data is available for at least one data management object of the one or more selected data management objects or computing memory usage data in real time when valid snapshot data is unavailable or incomplete for at least one data management object of the one or more selected data management objects.

A user interface is caused to be rendered to display information regarding the computer resource use footprint. Through the user interface, user input is received specifying one or more of an adjustment to a residence time for at least one data management object of the one or more data management objects or an adjustment to computer resources allocated to at least one data management object of the one or more data management objects.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 illustrates an example computing environment in which disclosed techniques for monitoring resource use by custom-defined object collections can be implemented.

FIG. 2 is a flowchart of a process for selecting ILM objects, retrieving resource use information for the objects, and displaying the results to a user.

FIG. 3 is an example user interface that allows a user to define custom ILM object selections, such as using search terms, including for a particular business area, or by manually selecting objects to be included.

FIG. 4 is an example user interface that displays resource use by custom-selected ILM object groups, and includes functionality to allow a user to take actions such as modifying a residence period for ILM object data or altering an amount of resources allocated to ILM objects.

FIG. 5 illustrates an example data model that includes objects that can be used to track memory usage, apply residence policies, and manage storage allocation for ILM objects based on precomputed memory snapshots.

FIG. 6 illustrates an example data model that includes objects that can be used to extend the functionality of the data model of FIG. 5 by enabling dynamic ILM object selection, real-time memory footprint calculations, and storage policy adjustments.

FIG. 7 is a flowchart of a process for analyzing computer resource usage for selected data management objects.

FIG. 8 is a diagram of an example computing system in which the described embodiments can be implemented.

FIG. 9 is an example cloud computing environment that can be used in conjunction with the technologies described herein.

### DETAILED DESCRIPTION

### Example—Overview of ILM Object Memory Footprint Analysis

ILM applications, such as ILM ADVISOR of SAP SE, are designed to provide insights into data volume growth and memory usage for Information Lifecycle Management (ILM) Objects. The application enables administrators to monitor memory consumption, analyze historical trends, and assess the potential impact of archiving strategies. By collecting memory footprint statistics and mapping them to ILM objects, ILM Advisor assists in optimizing data residence policies and reducing database size.

Residence, in the context of data management, refers to the duration for which data remains in a particular storage tier or location before being migrated, archived, or deleted. Residence policies define how long data is kept in high-performance storage, intermediate storage, or long-term archival storage based on access patterns, performance requirements, or cost considerations. While residence policies govern the movement of data across different storage tiers, they can be influenced by retention policies, which dictate how long data must be retained to comply with legal, regulatory, or business requirements.

For example, privacy regulations such as the General Data Protection Regulation (GDPR) or the California Consumer Privacy Act (CCPA) may impose strict retention limits on certain types of personal data, requiring that data be deleted or anonymized after a defined period. In such cases, residence policies may be adjusted to ensure compliance by ensuring that data is not only moved to lower-cost storage but also fully purged from all active and archived systems once retention obligations expire. Retention policies are often managed using retention objects, which specify predefined rules governing the required storage duration for different categories of data. These retention objects may be integrated into an information lifecycle management (ILM) framework, so that residence policies align with overarching compliance mandates.

Typical ILM applications rely on predefined configurations to track database tables associated with ILM objects. A background process periodically executes data collection jobs that retrieve memory usage statistics from a database, such as SAP HANA, aggregating table sizes and storing the results in a snapshot table. The collected data is used to generate reports displaying total memory usage, ILM object-specific footprint calculations, and growth trends over configurable time intervals. These reports help administrators assess storage allocation and determine whether archiving actions could free up memory.

These applications typically use a static selection of database tables, or selection criteria, such as those identified as significant based on predefined heuristics. The selection process can focus on tables classified as rapidly growing. The memory footprint of each ILM object can be estimated by summing the sizes of its associated tables, with calculations performed based on residence times and other ILM-specific conditions. Users can view these metrics within a user interface, such as one provided by an ILM FIORI (SAP, SE) application, which presents high-level summaries and detailed breakdowns of memory consumption patterns.

While prior techniques provide a structured approach to analyzing memory usage, they have several limitations. The typical reliance on predefined table selections restricts users from analyzing memory footprints beyond the default dataset. The techniques lacked the ability to provide dynamically selection criteria based on specific business needs, preventing organizations from tailoring the analysis to their unique data structures. Additionally, memory footprint calculations typically depended on periodic snapshot generation, meaning that insights were limited to precomputed data rather than real-time evaluations. This approach introduced delays in identifying memory-intensive areas, particularly in scenarios where rapid growth required immediate attention.

The present disclosure introduces a set of enhancements to ILM functionality that improve the flexibility, responsiveness, and accuracy of memory footprint analysis. One enhancement is the ability for users to define custom object sets for monitoring rather than relying on predefined selections. This capability allows organizations to tailor memory (or other computing resource use) analysis to business-specific data structures, so that ILM objects relevant to a particular use case are considered in footprint calculations. Instead of being limited to top-growing tables determined by system heuristics, users can select objects (mapped to corresponding tables or views) based on business area, process category, or other criteria, allowing for a more precise and actionable view of memory consumption.

ILM objects are specific example of data management objects. As used herein, the term “data management object” refers to a computer-implemented abstraction that represents data elements within a computing system, where each data management object is associated with one or more underlying data storage entities. Data management objects can include, but are not limited to, information lifecycle management (ILM) objects, database objects, archiving objects, structured business entities, or other logical representations of stored data. These objects serve as organizational constructs that facilitate the classification, retrieval, and processing of data across various applications and storage architectures. While ILM objects provide one example of data management objects, the disclosed techniques can be applied more broadly to any computing environment that organizes and tracks data resources using object-based abstractions.

As used herein, the term “data storage entity” refers to a structured, semi-structured, or unstructured data repository that retains data associated with one or more data management objects. Data storage entities can include, but are not limited to, database tables, database views, key-value stores, file system objects, document stores, object storage containers, log repositories, or other logical or physical storage structures.

Structured data storage entities, such as relational database tables, maintain well-defined schemas that enable precise mappings between data management objects and their underlying records. Semi-structured storage entities, such as JSON-based document databases or XML repositories, store data in formats that allow flexible schema evolution while still retaining definable relationships. Unstructured data storage entities, such as binary large objects (BLOBs), data lakes, or distributed file systems, may lack rigid schema constraints but can still be associated with data management objects through metadata tagging, indexing, or other reference mechanisms.

The introduction of real-time memory footprint calculation further expands the capabilities of ILM application by enabling on-the-fly analysis of ILM objects. Unlike prior implementations that relied on periodic snapshot generation, disclosed techniques dynamically retrieve table size and record count information when precomputed data is unavailable. By eliminating the dependency on scheduled data collection jobs, this feature provides a more responsive mechanism for identifying memory-intensive areas and evaluating the potential effects of archiving or data residence policy changes.

### Example—ILM Advisor Application Architecture and Data Collection Components

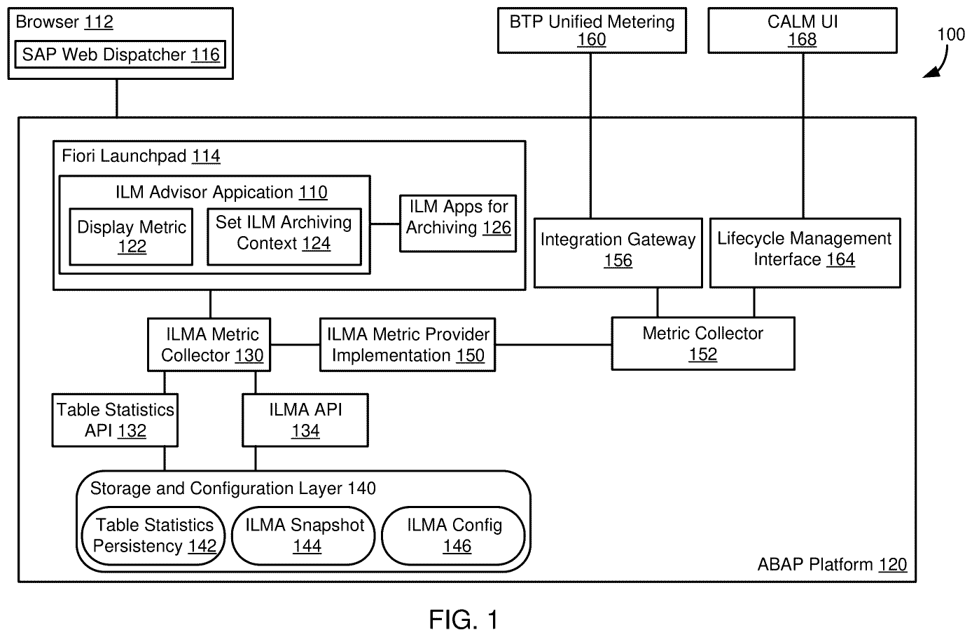

FIG. 1 illustrates a computing environment 100 that implements an ILM Advisor Application 110, designed to monitor and optimize memory usage within an enterprise database system. The discussion proceeds with specific reference to components of SAP ILM ADVISOR, but the disclosed techniques can be adapted for use with other ILM solutions, which can differ in implementation from FIG. 1 without departing from the scope of the present disclosure.

The ILM Advisor Application 110 is structured within an SAP ABAP platform 120, where the ILM Advisor Application operates as a FIORI-based application alongside various SAP system components.

SAP FIORI LAUNCHPAD 114 serves as the front-end user interface, providing system administrators with access to the ILM Advisor Application 110. A browser 112 acts as a primary entry point for users, allowing them to interact with ILM Advisor Application 110 through the SAP FIORI environment. Requests originating from the browser 112 are routed through the SAP WEB DISPATCHER 116, which functions as a reverse proxy and load balancer, directing communication between front-end users and SAP back-end services within the ABAP platform 120.

Within the SAP FIORI LAUNCHPAD 114, the ILM Advisor Application 110 integrates with multiple ILM-specific applications. Display Metric 122 and set ILM archiving context 124 provide mechanisms, respectively, for retrieving and setting ILM-related parameters, allowing administrators to configure data residence policies and monitor storage consumption trends.

The ILM Advisor Application 110 interfaces with external ILM applications 126 enabling archiving operations, aligning data residence policies with enterprise-wide governance strategies. These applications 126 function within the FIORI LAUNCHPAD and operate in conjunction with the ILM Advisor Application 110 to support long-term storage management and compliance monitoring.

To collect system performance metrics and analyze ILM storage trends, the ILM Advisor Application 110 interacts with an ILMA metric collector 130, which serves as an intermediate data aggregation module responsible for gathering table-level storage statistics and real-time ILM object growth data. The ILMA metric collector 130 is in communication with two SAP APIs: table statistics API 132 and ILMA API 134.

The table statistics API 132 is responsible for retrieving and analyzing total memory footprint data, record counts, and table growth trends based on historical database statistics. The ILMA API 134 provides access to configuration parameters, ILM object metadata, and residence policy settings, allowing the ILM Advisor Application 110 to dynamically adjust monitoring criteria based on system-defined rules.

Both APIs 132, 134 interface with a dedicated storage and configuration layer 140, such as a relational database, that maintains historical and active ILM data. The storage and configuration layer 140 includes table statistics persistency 142, an ILMA Snapshot 144, and an ILMA configuration 146. These components 142, 144, 146 collectively store historical storage metrics, ILM object memory footprints, and administrator-defined configuration parameters, allowing the ILM Advisor Application 110 to access both real-time and historical storage data for analysis.

The ILMA metric collector 130 also interacts with an ILMA metric provider implementation 150, which acts as a processing layer for metric aggregation and transformation. The ILMA metric provider implementation 150 processes raw database statistics, applies filtering criteria, and forwards structured ILM object metrics to downstream monitoring tools.

A metric collector 152 gathers system-wide ILM-related metrics and transmits them to the ILMA metric provider implementation 150, where they are processed for aggregation, filtering, or transformation. Acting as a centralized system monitoring module, the metric collector 152 collects raw system performance data related to ILM object storage, memory usage, and database activity. This collected data is then structured by the ILMA metric provider implementation 150, allowing ILM-related statistics to be formatted for downstream analysis and integration with external performance tracking services.

The computer environment 100 incorporates structured integration components that facilitate secure data exchange between the ILM system 110 and cloud services. These components manage the transmission of ILM Advisor Application performance data, storage analytics, and policy-driven residence insights, providing synchronization between the ILM Advisor Application 110 and centralized monitoring tools.

An integration gateway 156 serves as a data transmission bridge between the metric collector 152 and SAP's BUSINESS TECHNOLOGY PLATFORM (BTP) UNIFIED METERING 160. The integration gateway 156 component facilitates the structured reporting of API consumption, system performance metrics, and metering statistics, allowing metering infrastructure to track processing trends and system usage in real time. The integration allows administrators to evaluate how the ILM Advisor Application 110 is utilizing system resources, track API consumption rates, and optimize operational parameters accordingly.

A lifecycle management interface 164 provides a communication link between the metric collector 152 and an SAP CLOUD APPLICATION LIFECYCLE MANAGEMENT (CALM) UI 168. The lifecycle management interface 164 enables the transmission of system diagnostics, deployment status updates, and performance tracking insights to lifecycle management tools. Through this integration, administrators gain real-time visibility into ILM Advisor Application health, storage efficiency trends, and residence policy compliance. By leveraging this structured connection, the ILM Advisor Application 110 can be monitored through unified system oversight tools of the CALM UI 168.

### Example—Selecting ILM Objects for Memory Footprint Analysis

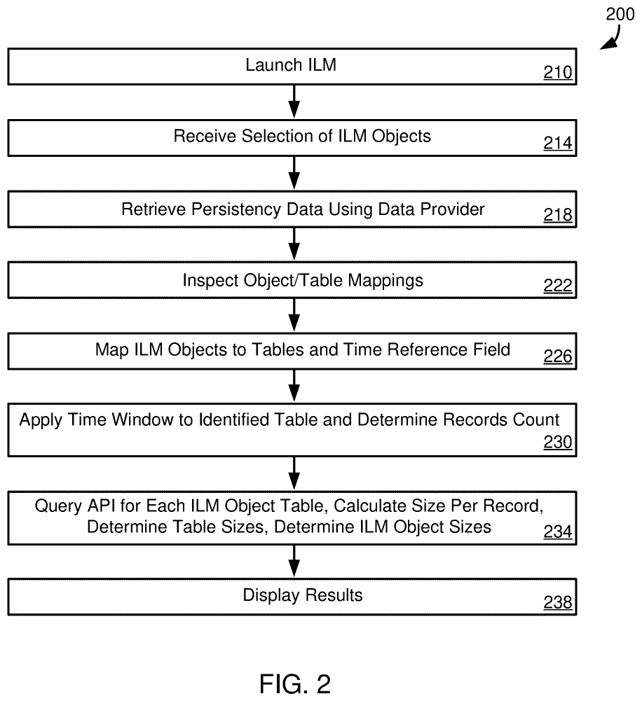

FIG. 2 provides a flowchart of a process 200 for defining a custom group of ILM objects, retrieving resource use information, and providing information about such use to a user, where the user may then perform actions such as modifying a residence period or adjusting computing resource allocation. At 210, an ILM application is launched, where a system initializes the application by setting up the ILM processing environment. This includes activating system components required to retrieve ILM-related data and preparing the user interface for object selection.

At step 214, the system receives ILM object selection input. Users may select ILM objects in multiple ways, such as directly choosing them from a displayed list, providing a list of ILM object identifiers, or searching for relevant objects based on user input. A search may involve specifying a business area, which prompts the system to retrieve associated ILM objects by referencing structured mappings in the database. This selection process allows users to focus on ILM objects based on business-driven criteria rather than solely on predefined system structures. Further, the use of keyword searches, either for business area or other ILM object characteristics, allows non-technical users to easily view resource use information for ILM objects of interest.

At 218, persistency data is retrieved using an ILM data provider. Operations at 218 can also include fetching stored ILM metadata, historical memory usage snapshots, and relevant residence parameters. The retrieved data is used for subsequent processing and calculations.

At 222, an inspect operation is performed that validates the mappings between ILM objects and their corresponding database tables, along with identifying the appropriate time reference field. The mapping process follows a structured hierarchy: SAP Object Type (SOT)→Business Object Repository (BOR)→ILM object→Archiving Object→Tables →Time Reference Field. This allows each ILM object to be correctly linked to its underlying data storage and ensures that the appropriate time attribute (such as creation date or last modified date) is available for residence analysis.

At 226, a time filter is applied to the identified database tables and the record count is determined. The time window, which can have a default value, such as 18 months, or can be configurable, including based on system settings or user input, defines the range of data considered for memory footprint calculations. The number of records falling within this period are determined, providing a quantifiable measure of data growth.

At 230, the relevant API is queried to retrieve per-record size statistics for each ILM object's associated data storage entity. Using this information, the system calculates total table sizes and memory footprints for the selected ILM objects. This calculation can incorporate one or both of stored snapshot data or dynamically computed values to reflect up-to-date storage usage.

At 234, the computed results are aggregates and formatted for analysis or display. This can include consolidating storage footprint data, applying any relevant residence-aware adjustments, and structuring the output for visualization.

At 238, the final memory footprint results are present in an ILM UI. The displayed data can include structured metrics such as table sizes, ILM object memory usage, and storage growth trends. Users can interact with this data to assess residence policies, evaluate storage trends, and identify potential areas for archiving or optimization.

### Example—Generating and Displaying Ilm Object Memory Reports

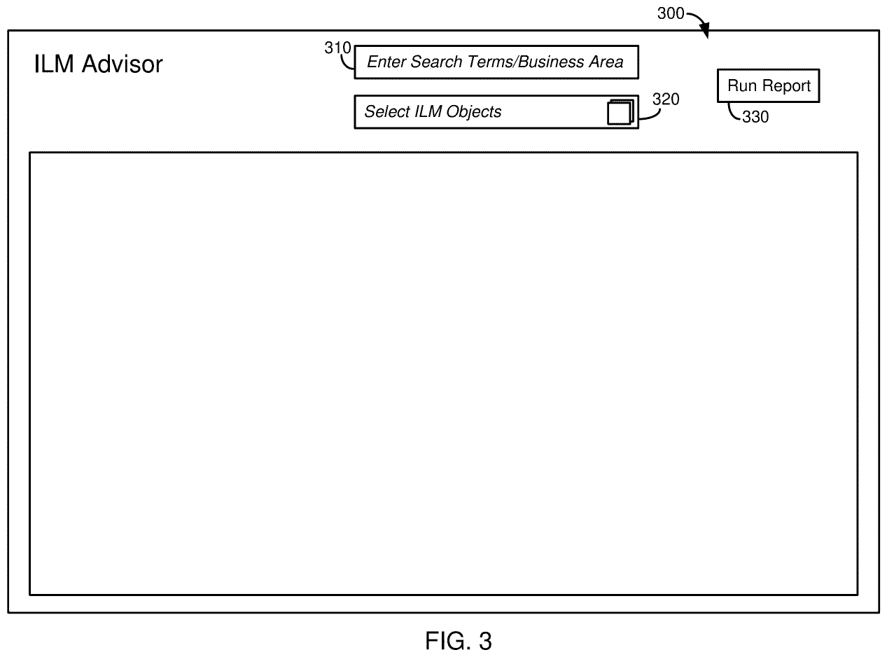

A user interface 300 depicted in FIG. 3 allows users to select ILM objects for analysis. The ILM objects can be selected indirectly or directly.

In one approach, a user interacts with UI element 310, which allows input of search terms or selection of a business area. When search terms or a business area are entered, the system processes the input to retrieve relevant ILM objects by querying structured mappings that associate ILM objects with business contexts, or using other ILM object data or metadata. This process enables the system to present ILM objects that correspond to user-defined criteria rather than requiring selection from a predefined list or looking at objects that have the fastest growing storage requirements across multiple areas.

Alternatively, a user can use UI element 320 to manual select ILM objects. A user may navigate through a list of available ILM objects and select them individually, rather than using search-based retrieval.

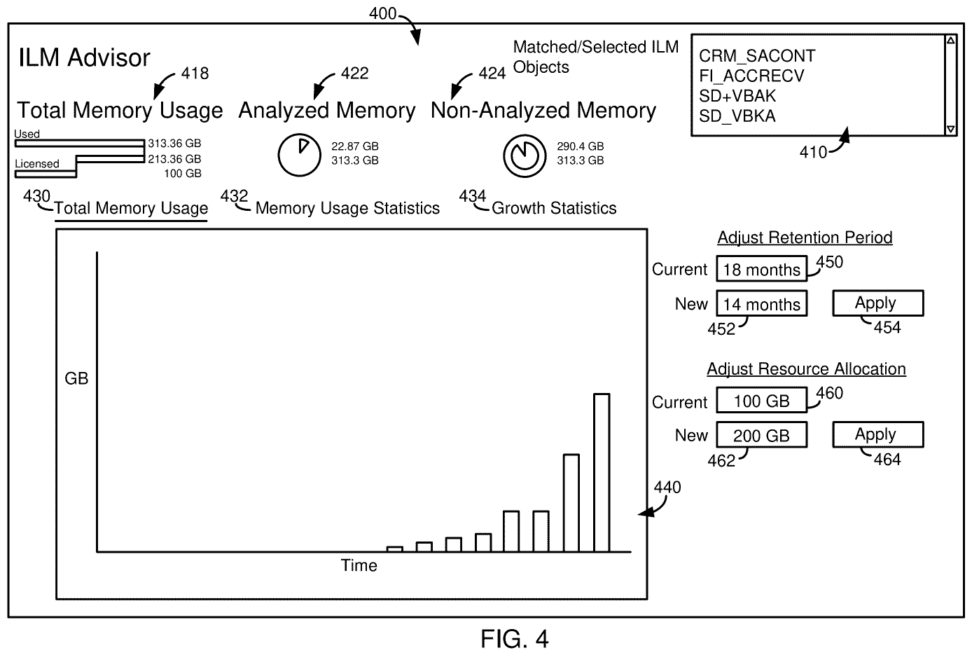

Once the user has either searched for or manually selected ILM objects, they proceed by selecting UI element 330, which causes report generation functionality to be executed. Upon activation, the underlying software gathers persistency data, performs memory footprint calculations, and retrieves stored snapshots or triggers on-the-fly computations as needed. The results of a report triggered using the UI element 330 can be displayed in a user interface 400 of FIG. 4.

The user interface 400 of FIG. 4 presents the results of an ILM memory analysis report initiated using user interface 300. The selection criteria entered in the user interface 300 of FIG. 3, whether through search terms, business area input, or manual ILM object selection, determine the ILM objects displayed in UI element 410. This element lists the ILM objects analyzed, allowing users to review the scope of the report.

The user interface 400 presents detailed memory usage statistics, including total memory usage for all ILM objects, as shown in details 418. These details include the total amount of memory used, the amount of memory currently licensed to the user, and the delta, which represents the difference between the two. This section allows users to assess how storage consumption aligns with available resources.

Further breakdowns of memory usage are provided in details 422 and 424. Details 422 represent resources corresponding to the selected ILM objects. Details 424 provide information regarding total storage use by ILM objects that were not part of the selection. The details 422, 424 allow users to better determine how the selected ILM objects are contributed to resource use.

A graph 440 displays memory usage trends over time for the selected ILM objects. This graphical representation provides insight into how memory consumption has changed, allowing users to identify patterns in storage growth. The graph may be based on historical snapshot data, on-the-fly calculations, or a combination of both, depending on the availability of stored metrics. If growth exceeds a desired pace or is likely to result in insufficient computing resources, a user can take actions such as altering a residence period or adjusting available resources.

A current residence period is displayed in UI element 450, while UI element 452 provides a field for entering a new residence period. Once a new value is entered, the user can apply the update by selecting UI element 454. Adjusting the residence period may result in several possible system operations. Reducing the residence period can result in data migration to cold storage, allowing older data to be archived in lower-cost storage tiers while freeing up active storage. This can include migrating data from memory to persistent storage, such as disk storage. It may also trigger deletion of expired records if the adjusted residence policy dictates that certain data no longer needs to be retained. Increasing the residence period may cause data to remain in active storage longer, potentially requiring additional storage resources.

A resource allocation section provides another layer of control over ILM object storage and performance settings. The current resource allocation is displayed in UI element 460, with UI element 462 allowing the user to enter a new allocation value. By selecting UI element 464, the user can apply the updated resource settings. Increasing resource allocation may involve expanding memory allocation for the ILM Advisor Application, provisioning additional storage capacity, or adjusting database parameters to accommodate higher data residence demands. Reducing resource allocation may involve reallocating storage tiers or triggering data compression or archiving processes to reduce active storage consumption.

### Example 5—Core Data Model for ILM Object Tracking and Storage Analysis

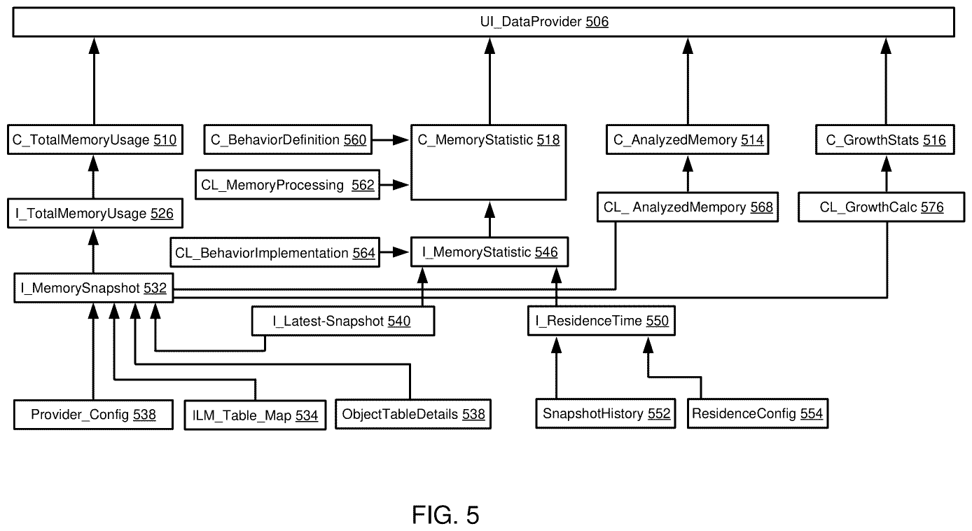

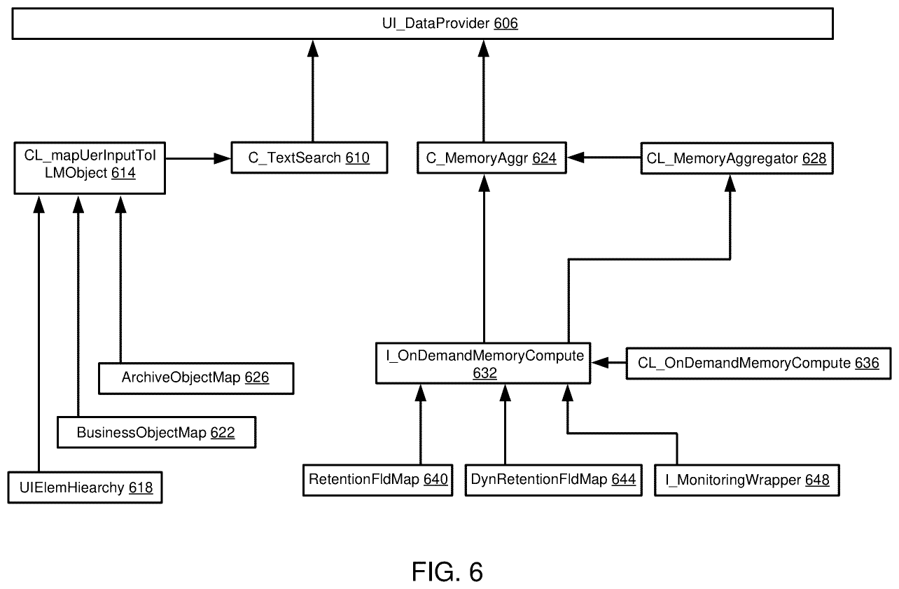

FIGS. 5 and 6 provide example data models that include data objects, such as table, views, or classes, that can be used to execute ILM object selection and resource use analysis. FIG. 5 provides a core data model 500 that can be used to implement disclosed techniques. The core data model 500 generally includes data objects, such as tables, views, classes, or class methods, that can be used to obtain memory (or other resource) use statistics for tables associated with particular ILM objects. The functionality of the core data model 500 can be leveraged by objects in a supplemental data model 600 of FIG. 6, where the supplemental data model provides functionality to identify ILM objects and their associated tables based on user input, assisting with resource use calculations.

In FIG. 5, a C_TotalMemoryUsage view 510 provides aggregated memory consumption statistics for ILM objects, providing information as to how storage is allocated and how it changes over time. Data objects prefaced by “C” represent consumption views, where a consumption view is a structured representation of processed and aggregated data designed for analytical consumption and reporting. Unlike raw database tables that store transactional or operational data, a consumption view typically consolidates relevant metrics, applies filtering and transformation logic, and presents data in a format optimized for querying, visualization, and decision-making. These views are typically used in analytical applications, dashboards, and reports to provide end users with meaningful insights without requiring complex joins or transformations at query runtime.

A C_AnalyzedMemory consumption view 514 processes and filters memory footprint data, allowing the system to focus on the most relevant ILM objects based on predefined criteria. A C_GrowthStats consumption view 516 tracks memory growth trends over time intervals, assisting in residence planning by identifying ILM objects with rapid data expansion. A C_MemoryStatistic consumption view 518 provides processed storage footprint data that supports detailed reporting on memory allocation across ILM objects, enabling administrators to assess usage patterns and identify optimization opportunities.

A UI_DataProvider 506 serves as an intermediary layer that retrieves data from C_TotalMemoryUsage 510, C_AnalyzedMemory 514, C_GrowthStats 516, and C_MemoryStatistic 518 and formats the results for presentation in a UI. When an administrator accesses the ILM Advisor interface, UI_DataProvider 506 dynamically queries the appropriate consumption views based on the selected filters, time periods, or ILM objects. This integration allows the system to, in some scenarios, provide on-demand insights while leveraging precomputed storage metrics, so that users receive timely and relevant memory footprint data without incurring unnecessary computation overhead. The details of each consumption view, including its function, relationships with other system components, and its role in an ILM data management workflow, are now discussed in further detail.

The C_TotalMemoryUsage view 510 consolidates memory footprint statistics from both real-time and historical sources to provide an overall storage consumption summary. It derives its data from an I_TotalMemoryUsage view 526, which serves as the primary intermediary processing layer. A providerID attribute of views 510 and 526 links records across multiple views, associating memory usage data with a specific ILM monitoring configuration. A snapshotMonth attribute provides a time-based reference that allows trend analysis and aligns records with historical snapshots stored in I_MemorySnapshot 532. A monthlyAggrdILMObjMmrySize attribute aggregates ILM object storage data from I_TotalMemoryUsage 526, which in turn retrieves memory footprint statistics from I_MemorySnapshot 532. The I_MemorySnapshot view 532 collects data from multiple underlying tables, including Provider_Config 538, ILM_Table_Map 534, and ObjectTableDetails 538, so that memory usage calculations incorporate relevant ILM object associations and storage allocations.

The I_TotalMemoryUsage view 526 serves as a transformation layer that processes memory footprint records retrieved from I_MemorySnapshot 532. Each record in this view links to an ILM object through the providerID and ILMObjMemorySize attributes. The snapshotMonth attribute provides a time reference, ensuring alignment with the snapshot repository. This view 526 retrieves storage footprint statistics directly from I_MemorySnapshot 532, filtering and refining them before passing the data to C_TotalMemoryUsage 510 for aggregation. It also cross-references ILM object mappings stored in ILM_Table_Map 534, so that memory footprint calculations include only relevant database tables.

The I_MemorySnapshot view 532 provides historical memory usage statistics. It stores periodic memory footprint records linked to specific ILM objects, with a providerID attribute ensuring that snapshots remain associated with the correct monitoring configuration. A snapshotMonth attribute timestamps each record, allowing storage metrics to be retrieved for specific time periods. An ILMObjMemorySize attribute captures storage allocation metrics for a given ILM object, with data sourced from the underlying database tables mapped in ILM_Table_Map 534 and ObjectTableDetails 538. The Provider_Config table 538 governs the configuration settings that determine how ILM objects and their corresponding tables are monitored. When a new snapshot is generated, the system references Provider_Config 538, ILM_Table_Map 534, and ObjectTableDetails 538 to determine which database tables should be included in footprint calculations. Additionally, an I_LatestSnapshot view 540 is used to verify whether a more recent snapshot is available before triggering new footprint calculations.

The C_MemoryStatistic view 518 provides structured memory footprint statistics for ILM objects, offering a detailed breakdown of storage allocation across different ILM monitoring configurations. Unlike C_TotalMemoryUsage 510, which focuses on broad aggregation, C_MemoryStatistic 518 provides structured statistics optimized for analytical queries and user interface reporting. It includes a providerID attribute, which links each record to a specific ILM monitoring instance. A resTime attribute records the residence time associated with the ILM object, influencing residence-based footprint calculations. The objectType attribute categorizes the ILM object based on its classification within the system, while the objectDescription attribute provides a human-readable description of the object. The timePotential attribute tracks potential time-based adjustments that impact storage footprint calculations, and the lastChangedBy attribute records the last user or process to modify the record, supporting auditability and historical tracking.

An I_MemoryStatistic view 546 serves as the processing layer that structures and organizes storage footprint data before it is passed to C_MemoryStatistic 518. Like its consumption view counterpart, it includes a providerID attribute to maintain consistency across ILM monitoring instances. The resTime attribute defines the residence period applied to the memory statistics, determining whether an ILM object remains in active storage calculations or is marked for archival. The objectType and objectDescription attributes provide additional classification and descriptive information about each ILM object. The timePotential attribute represents projected storage usage trends based on past footprint behavior, while the lastChangedBy attribute records the last entity to update the record.

An I_LatestSnapshot view 540 supports snapshot validation for I_MemoryStatistic 546 and C_MemoryStatistic 518, helping to align storage footprint calculations with the most recent available memory snapshot. It includes a providerID attribute, linking each snapshot reference to a specific ILM monitoring configuration. A snapshotMonth attribute timestamps each snapshot, associating memory calculations with the appropriate time period.

Residence time data is tracked through I_ResidenceTime 550, which records how long ILM objects have been present in the system. A providerID attribute maintains linkages between residence time records and ILM monitoring instances, supporting retrieval and analysis of stored data. A resTime attribute represents the actual duration an ILM object has existed in the system, aiding in storage trend analysis and residence decisions. By analyzing residence time values, the system can estimate the cumulative impact of long-retained objects on memory footprint calculations.

A SnapshotHistory table 552 tracks historical memory footprint data, storing past consumption values to support long-term trend analysis and capacity planning. It includes a snapshotMonth attribute, which timestamps each stored record. A snapshotDate attribute records the exact date the snapshot was taken, providing finer granularity for memory tracking. The records attribute captures the number of database records included in each snapshot, while the size attribute logs the total memory footprint at the time of capture. A totSizeRatio attribute calculates the ratio of the total footprint size relative to past snapshots, assisting in growth trend analysis. Attributes of changedDate and changedTime record the most recent modifications to a stored snapshot, preserving an audit trail for historical reference.

A ResidenceConfig table 554 defines residence policies that influence memory footprint calculations, providing default residence time values, which can be overridden by user-configurable settings. A providerID attribute links residence rules to the appropriate ILM monitoring configuration. A residenceTime attribute sets the baseline residence period for ILM objects, while a residenceTimeUser attribute records any user-defined adjustments to the default residence policy.

By integrating these elements, C_MemoryStatistic 518 serves as a structured analytical layer that refines ILM object storage data using processing rules from I_MemoryStatistic 546, snapshot validation from I_LatestSnapshot 540, residence enforcement through I_ResidenceTime 550, and historical tracking through SnapshotHistory 552. The system supports flexible storage footprint calculations by applying both predefined residence rules and user-modified configurations from ResidenceConfig, allowing ILM Advisor to generate memory footprint statistics that are both structured and adaptable to changing storage policies.

In addition to the structured attribute relationships that define how ILM object memory footprint data is stored and referenced, behavioral processing modules further refine how memory statistics are classified and presented within C_MemoryStatistic 518. These processing components define the logic that governs memory footprint calculations, applying system-defined classification models that influence how ILM objects are categorized based on residence status, growth projections, and administrative policies. While C_MemoryStatistic 518 and I_MemoryStatistic 546 structure footprint data for reporting and analysis, the behavioral and processing modules dictate how these views interpret and transform the underlying data to generate meaningful insights.

A C_BehaviorDefinition view 560 serves as an intermediary processing layer that provides structured classification rules to C_MemoryStatistic 518. Rather than storing raw footprint data, it applies pre-defined logic that determines how ILM objects are categorized based on residence policies, growth trends, or other administrative parameters.

A CL_MemoryProcessing module 562 works alongside C_BehaviorDefinition 560 to implement processing logic that determines how footprint calculations are adjusted based on classification rules. C_BehaviorDefinition 560 can include an attribute specifying an algorithm for refining footprint calculations, incorporating growth-based segmentation, residence policies, or user-defined parameters.

A CL_BehaviorImplementation module 564 defines the processing logic applied to I_MemoryStatistic 546, such that structured memory statistics conform to behavioral classification rules before being passed to C_MemoryStatistic 518. This module 564 applies system-defined classification strategies that account for ILM residence settings, snapshot alignment, and administrative storage policies.

The C_AnalyzedMemory view 514 refines memory footprint analysis by applying ILM-specific residence rules, filtering logic, and snapshot-based comparisons. Unlike C_TotalMemoryUsage 510, which provides a broad aggregation of ILM object memory statistics, C_AnalyzedMemory 514 focuses on storage that remains relevant after considering residence policies, recent usage trends, and snapshot history. C_AnalyzedMemory 514 integrates multiple data sources, including processing modules, historical snapshots, and ILM residence configurations, to generate a more focused representation of ILM object storage footprints. It includes a totalMemorySize attribute, which captures the total memory footprint of a given ILM object, and a licensedMemorySize attribute, which records the portion of memory covered by a system license. An analyzedMemorySize attribute stores the portion of the ILM object's memory that remains relevant after residence-based filtering, while a notAnalyzedMemorySize attribute tracks the excluded portion of the memory footprint. A deltaMemorySize attribute represents changes in the analyzed memory footprint over time, and a deltaChartColor attribute assigns a visual classification to the memory footprint delta, enhancing user interface reporting for intuitive visualization.

A CL_AnalyzedMemory class 568 processes the structured memory footprint data used by C_AnalyzedMemory 514. The class 568 applies classification rules that determine how ILM object memory footprints are filtered and adjusted based on predefined ILM residence policies. This class 568 incorporates filtering logic that distinguishes between actively retained and non-retained storage, so that C_AnalyzedMemory 514 accurately represents storage statistics after policy-based adjustments have been applied.

The I_MemorySnapshot table 532 provides structured snapshot data that serves as a primary input to CL_AnalyzedMemory 568. Each snapshot in I_MemorySnapshot captures ILM object memory footprints at a specific point in time, allowing for historical comparisons and storage trend analysis. By referencing I_MemorySnapshot 532, CL_AnalyzedMemory 568 can track how ILM object memory consumption changes over multiple snapshot periods, supporting residence-based decision-making using C_AnalyzedMemory 514.

The C_GrowthStats view 516 tracks memory growth trends across ILM objects, allowing administrators to track and analyze storage expansion over time. Unlike C_AnalyzedMemory 514, which filters memory footprint data based on residence policies, C_GrowthStats 516 calculates and presents storage growth metrics over predefined time intervals. These growth statistics support proactive residence and archiving decisions by identifying ILM objects that exhibit rapid data accumulation. A providerID attribute links growth statistics to the appropriate ILM monitoring configuration, maintaining consistency across data retrieval operations.

A resTime attribute records the residence time associated with each ILM object, influencing whether its storage footprint remains relevant in long-term trend analysis. An objectType attribute categorizes the ILM object based on its role in the system, while a objectDescription attribute provides a human-readable description of the object. A rankValue attribute assigns a ranking to each ILM object based on its relative storage growth rate, distinguishing rapidly expanding objects from those with stable or declining memory usage.

A changeInMemoryPercentageValue attribute captures the computed rate of storage expansion as a percentage, providing insight into how much an ILM object's memory footprint has changed over time. A changeInMemorySize attribute tracks the absolute change in storage footprint, complementing the percentage-based growth metric. A totalMemorySize attribute records the total storage footprint of the ILM object, providing data for capacity planning and resource allocation.

A filterByMonths attribute defines the time period over which storage growth is assessed, allowing administrators to analyze trends over different intervals. A snapshotAnalysisDate attribute timestamps the growth analysis, associating the recorded expansion trends with a specific evaluation period.

A CL_GrowthCalc class 576 provides the computational logic required to derive the growth statistics presented in C_GrowthStats 516. The class 576 applies mathematical models to analyze historical memory snapshot records, compute percentage-based growth trends, and project future storage needs. The CL_GrowthCalc class retrieves historical storage footprint data from I_MemorySnapshot 532, which serves as the foundational data source for its growth analysis. I_MemorySnapshot 532 records past ILM object memory footprints, providing a basis for computing storage expansion trends. By comparing memory snapshot data across multiple periods, CL_GrowthCalc 576 identifies patterns in storage consumption and generates predictive insights that inform residence and capacity planning decisions.

### Example 6—Supplemental Data Model for Custom ILM Object Selection and Computation

As discussed, disclosed techniques provide greater flexibility in providing information about ILM objects and associated tables, including for purposes such as capacity planning or adjustment of residence rules. FIG. 6 provides a supplemental data model 600 that can be used with the data model 500 of FIG. 5 to provide memory use information for user-defined ILM object selections.

The data model 600 introduces components designed to extend ILM capabilities by enabling dynamic ILM object selection, facilitating on-demand memory footprint analysis, and integrating real-time computation with structured residence tracking. An ILM framework, as represented by the previously described data model 500, provides foundational mechanisms for memory footprint tracking, residence policy enforcement, and archiving object mappings. However, most existing solutions primarily rely on predefined object mappings and precomputed memory snapshots, limiting ILM operation flexibility and responsiveness. The enhancements introduced in the data model 600 address these limitations by allowing administrators (or other users) to dynamically search for ILM objects using business-relevant terms and by enabling real-time computation of ILM memory footprints rather than relying exclusively on stored snapshots or static selection criteria.

The data model 600 includes a data provider 606, which can correspond to a data provider 506 of FIG. 5. The data provider 606, which can be an OData provider, serves as a main interface for retrieving ILM memory statistics and ILM object selections. The data provider 606 integrates with two key consumption views: C_TextSearch 610, which enables dynamic ILM object identification, and C_MemoryAggr 624, which aggregates computed memory footprint values for real-time analysis. These views 610, 624 improve interactivity and responsiveness by allowing administrators to search for ILM objects based on business-area-driven criteria and to immediately assess memory utilization for selected objects without relying solely on historical snapshot data or static sets of ILM objects and associated tables.

The C_TextSearch view 610 interacts with the data provider 606 to support dynamic ILM object retrieval based on user-entered search terms. Unlike prior implementations restricted to tables experiencing the highest amount of growth, the view 610 allows users to search for relevant objects using keywords, business areas, or partial object names. The retrieval process is context-aware, leveraging structured mappings from a BusinessObjectMap 622 and a UIElemHierarchy 618 so that search results align with system-defined ILM object relationships. The data provider 606 queries C_TextSearch 610 when a user initiates a search request, returning structured ILM object data that is then presented in the ILM Advisor interface.

Once an ILM object is selected, the C_MemoryAggr view 624 provides on-demand memory footprint aggregation, so that administrators can immediately analyze storage utilization trends associated with selected ILM objects. This view 624 integrates stored snapshot data with real-time computed memory values, providing a more dynamic and up-to-date representation of ILM memory statistics. Unlike conventional approaches that rely exclusively on historical memory snapshots, C_MemoryAggr 624 interacts with an I_OnDemandMemoryCompute view 632 to trigger real-time footprint calculations when necessary. The data provider 606 queries C_MemoryAggr 624 when a user requests ILM object memory statistics, so that both historical and computed values are accessible for analysis and residence planning.

Through the integration of these new components, disclosed techniques enhance both ILM object selection and memory footprint analysis, providing a more flexible, interactive, and responsive framework for managing residence and archiving decisions. The following discussion provides more detail regarding C_TextSearch 610 and C_MemoryAggr 624, outlining their structure, attributes, and interactions with other components within an enhanced ILM framework.

The C_TextSearch view 610 enables dynamic ILM object selection, allowing users to retrieve ILM objects through free-text search rather than relying on predefined lists or static mappings. This represents a significant enhancement to an ILM Advisor Application's usability by making it easier to identify relevant ILM objects based on business context, rather than requiring technical knowledge of ILM Advisor Application identifiers. The C_TextSearch 610 includes an object type attribute, a freetext attribute, a BO (business object) attribute, and an ARC_Obj (archiving object) attribute.

C_TextSearch 610 interacts with a CL_mapUserInputToILMObject class 614, which is responsible for parsing search terms and mapping them to ILM objects. This class 614 takes a user-provided query, such as a business area name, partial ILM object name, or table reference, and cross-references it against ILM object mappings stored in a BusinessObjectMap table 622 and a UIElemHierarchy table 618. UIElemHierarchy 618 includes a name attribute, an active attribute, an activelang attribute, a parent attribute, a progname attribute, and an editelem attribute. The BusinessObjectMap table 622 includes an object type attribute and a BOR_Object attribute.

A CL_mapUserInputToILMObject 614 executes several processing steps to resolve user input into structured ILM object records. It first standardizes text input by applying normalization and tokenization techniques to handle naming variations. Once formatted, the function performs a lookup against a BusinessObjectMap 622, which maintains predefined associations between business objects and ILM objects. This process links user input with structured SAP BOR (Business Object Repository) data, allowing search results to align with business object hierarchies rather than technical object names alone.

An ArchiveObjectMap 626, accessible by a class 614, stores structured relationships between ILM objects and their associated archiving definitions. Each record in an ArchiveObjectMap 626 includes an object type attribute and an arch_object attribute.

C_MemoryAggr 624 functions as a primary aggregation layer for ILM memory footprint analysis, consolidating both historical memory snapshots and dynamically computed memory statistics to provide a real-time view of storage utilization. Unlike traditional ILM tracking mechanisms that rely solely on precomputed snapshots, this view introduces adaptive memory footprint computation, so that residence and archiving decisions are informed by the most up-to-date data. C_MemoryAggr 624 includes an object type attribute, a freetext attribute, a BO attribute, an arc_obj attribute, and an AO_table_mem attribute.

A CL_MemoryAggregator 628 includes an aggregate method. An I_OnDemandMemoryCompute 632 includes attributes such as freetext, BO, arc_obj, AO_Table_mem, AO_tables, AO_data, AO_records, and AO_TMC_ratio. The CL_OnDemandMemoryCompute 636 class provides methods, including inspect, collect, and calculate.

Following the retrieval of ILM objects from C_TextSearch 614, the selected objects are processed within the ILM tracking and residence workflow. If an ILM object is selected for further analysis, additional queries are used to retrieve real-time memory footprint data. The C_MemoryAggr view 624 provides this functionality by aggregating memory statistics for selected ILM objects, incorporating both stored snapshot data and on-demand computation results. The transition from ILM object identification to ILM memory footprint analysis allows ILM administrators to search for relevant objects and immediately assess their impact on system memory utilization.

Each record in C_MemoryAggr 624 contains attributes that track the relationship between stored memory data and computed values. An object type attribute categorizes ILM objects according to their function within the framework. A freetext attribute stores user-entered search terms, while BO (business object) and arc_obj (archiving object) attributes establish structured relationships with ILM entities. Additionally, an AO_table_mem attribute represents memory footprint values associated with the selected archiving object.

C_MemoryAggr 624 interacts with a CL_MemoryAggregator class 628 to perform aggregation operations, so that memory footprint values are computed and structured appropriately. When required, an I_OnDemandMemoryCompute view 632 dynamically calculates ILM object memory utilization based on real-time data retrieval. This process incorporates multiple data sources, including AO_tables, AO_data, and AO_records, which contribute to overall storage assessments.

I_OnDemandMemoryCompute 632 serves as a computational backend for real-time ILM object memory footprint estimation. This view is activated when no valid snapshot data is available, triggering a structured retrieval and calculation sequence. I_OnDemandMemoryCompute 632 includes a freetext attribute, a BO (business object) attribute, an arc_obj attribute, an AO_Table_mem attribute, an AO_tables attribute, an AO_data attribute, an AO_records attribute, and an AO_TMC_ratio attribute.

The execution of real-time calculations in I_OnDemandMemoryCompute 632 is handled by CL_OnDemandMemoryCompute 636, a class that applies structured processing logic. This class provides inspect, collect, and calculate methods, which execute sequentially to determine real-time computation needs, retrieve storage statistics, and apply ILM-specific data processing.

A CL_MemoryAggregator 628 builds on this process by performing high-level aggregation logic, consolidating both precomputed and dynamically computed memory statistics into a unified footprint assessment. A CL_MemoryAggregator 628 includes an aggregate method that processes memory usage data and long-term storage trends.

An I_MonitoringWrapper 648 interface structures real-time ILM object monitoring data, capturing structured monitoring statistics for ILM objects. A TableSnapshotDateTime attribute records a timestamp records a timestamp of the most recent database memory snapshot. A TableName attribute identifies an associated SAP HANA database table. A NumberOfTableRecords attribute captures the number of records stored in the table, and a TableTotalMemorySizeInBytes attribute tracks the table's allocated memory.

### Example 7—Integration of ILM Data Models for Real-Time Memory Footprint Computation

This Example describes how the data model 500 of FIG. 5 and the data model 600 of FIG. 6 interact to determine resource use by selected ILM objects. C_MemoryAggr 624 interacts with the RetentionFldMap 640 and DynRetentionFldMap 644 to apply residence-based adjustments to storage utilization calculations. The RetentionFldMap 640 includes the object type, startime_type, table_name, and table_field_name attributes. The DynRetentionFldMap 644 extends this functionality by allowing modifications to residence policies at runtime and includes the same attributes.

By integrating historical snapshot retrieval, real-time computation, structured monitoring, and residence-aware processing, C_MemoryAggr 624 enables the ILM application to apply an adaptive ILM object storage tracking system. Through its interaction with the C_TextSearch 610, administrators can first search for relevant ILM objects dynamically, then immediately retrieve and analyze their memory utilization statistics. The addition of on-demand memory computation functionality provides accurate, real-time storage assessments, reducing reliance on fixed snapshot intervals and expanding the flexibility of storage tracking, residence planning, and archiving workflows.

The data model 600 extends the data model 500, introducing features that enable dynamic ILM object selection, on-demand memory footprint analysis, and real-time residence-aware computations. These features build upon prior ILM tracking, which use predefined object mappings and precomputed memory snapshots, by allowing interactive, responsive, and user-driven data analysis.

The data provider 506, 606 functions as a central interface for accessing ILM object data and memory statistics, interacting with both the data model 500 and the data model 600 to provide real-time data retrieval and analysis. Through the C_TextSearch 610, the data provider 506, 606 allows dynamic ILM object identification, enabling users to perform text-based searches for ILM objects using business-relevant criteria rather than relying on technical system mappings. Once an ILM object is selected, the data provider 506, 606 queries the C_MemoryAggr 624, retrieving aggregated memory footprint statistics that incorporate stored snapshot data and dynamically computed values.

The data model 600 does not replace the data model 500 but expands its functionality by introducing a flexible data retrieval and computation layer. The data model 500 continues to provide foundational memory tracking components, including the C_TotalMemoryUsage 510, C_AnalyzedMemory 514, and C_GrowthStats 516, which apply memory footprint aggregation, filtering, and growth trend analysis. The data model 600 interacts with these components by adding dynamically computed values when necessary, enabling ILM memory footprint assessments that reflect real-time storage conditions.

The C_TotalMemoryUsage 510 view, which aggregates memory footprint statistics from historical and real-time sources, benefits from additional processing logic introduced by the data model 600. This view primarily retrieves data from the I_TotalMemoryUsage 526, which refines memory records retrieved from the I_MemorySnapshot 532. While the data model 500's snapshot data provides historical tracking and benchmarking, the data model 600 introduces the I_OnDemandMemoryCompute 632, which applies real-time footprint calculations when snapshot data is missing or outdated. Through the C_MemoryAggr 624, the system dynamically selects whether to use precomputed or real-time values, allowing ILM object memory footprint assessments to remain current.

The C_AnalyzedMemory 514 view benefits from the data model 600's ability to process and filter memory footprint data in real time. The data model 500's residence-aware filtering logic, which incorporates residence time configurations and historical snapshot references, is now augmented by real-time computed values retrieved from the I_OnDemandMemoryCompute 632. By incorporating these computed values, C_AnalyzedMemory 514 refines storage footprint filtering and residence-based exclusions to reflect live system conditions rather than relying solely on predefined ILM object tracking thresholds.

C_GrowthStats 516 tracks longitudinal memory growth trends to assist in residence planning and predictive storage analysis. The data model 500 uses historical ILM object storage data retrieved from the I_MemorySnapshot 532, while the data model 600 allows real-time computed values to supplement the growth trend analysis pipeline. CL_GrowthCalc 576, which implements storage growth rate calculations and forecasting models, now integrates computed footprint values alongside historical data, allowing predictions to reflect current system behavior instead of being constrained by snapshot intervals.

At an infrastructure level, the Provider_Config table 538, which defines ILM monitoring parameters and residence policies, continues to influence snapshot residence settings and database mappings within ILM_Table_Map 534. However, the data model 600 introduces the RetentionFldMap 640 and DynRetentionFldMap 644, which allow real-time modifications to residence settings, making policy adjustments dynamically reflected in footprint calculations. These components refine how ILM objects are mapped to storage tables and how residence rules are applied during memory footprint assessments, enabling the system to dynamically adjust storage calculations based on updated residence configurations.

A notable component of the data model 600 is the I_MonitoringWrapper 648, which serves as a real-time monitoring interface for ILM object memory tracking. This component interacts with both stored snapshots and on-demand computed values, maintaining consistency across historical and real-time computation layers. By tracking SAP HANA table-level statistics, including the TanatableSnapshotDateTime, HANATableName, NumberOfHANATableRecords, and HANATableTotalMemorySizeInBytes, the I_MonitoringWrapper 648 provides a structured approach for integrating computed memory values into the ILM Advisor's broader tracking and benchmarking operations.

A combination of stored memory snapshots, on-demand computation, and residence-aware filtering mechanisms allows the ILM Advisor to adapt to live system conditions while maintaining structured benchmarking and historical analysis capabilities. While the data model 500 provides ILM object tracking, memory footprint aggregation, and growth analysis, the data model 600 allows real-time analysis, user-driven selection, and immediate residence-aware adjustments. This hybrid approach allows ILM tracking to remain aligned with real-time conditions while preserving structured analytical models required for long-term storage planning.

Various techniques can be used to integrate the data models 500 and 600. Direct table extension, SAP enhancement frameworks, separate but linked tables, and middleware-driven integration provide various methods for merging these models. Each approach determines how ILM object memory footprints, residence-aware settings, and computed values are structured, so that the ILM Advisor maintains a comprehensive and adaptable framework for storage tracking and planning.

Regardless of the integration strategy, structured decision logic governs ILM object memory footprint selection, where snapshot data is retrieved from the I_MemorySnapshot 532 when available, and real-time computation occurs through the I_OnDemandMemoryCompute 632 as needed. Residence-aware adjustments applied via the RetentionFldMap 640 and the DynRetentionFldMap 644 align memory footprint values with real-time residence policy updates.

### Example 8—Querying and Computing ILM Object Memory Footprints

TThe following describes how objects in data models 500 and 600 are used, particularly when a user enters search terms that are used to select ILM objects for analysis. When a user selects a business area such as “Sales” within the SAP Fiori UI, the system initiates a query to determine which ILM objects correspond to that business area. The selected business area is processed using C_TextSearch 310, which enables dynamic ILM object retrieval. The system retrieves the relevant ILM objects by executing a query that searches for matches within BusinessObjectMap 322 and UIElemHierarchy 318. An example SQL statement for this retrieval is:
SELECT b.ilmo_object_id, b.ilmo_object_name
FROM BusinessObjectMap b
JOIN UIElemHierarchy u ON b.business_area_id=u.business_area_id
WHERE u.business_area_name=‘Sales’;

Once the relevant ILM objects have been identified, they are processed using application logic. Within the ABAP RAP framework, this may involve calling a class method responsible for retrieving ILM objects based on user input. A representative ABAP method invocation is:
DATA(lo_business_area)=NEW zcl_business_area().
DATA(lt_ilmo_objects)=lo_business_area->get_ilmo_objects(EXPORTING iv_business_area=‘Sales’).

After retrieving the ILM objects, the system determines which database tables correspond to these objects. This is accomplished through ILM_Table_Map 534, which maintains mappings between ILM objects and the tables storing their associated data. The database query to retrieve these mappings might take the following form:
SELECT t.table_name, t.ilmo_object_id
FROM ILM_Table_Map t
WHERE t.ilmo_object_id IN (
SELECT b.ilmo_object_id
FROM BusinessObjectMap b
JOIN UIElemHierarchy u ON b.business_area_id=u.business_area_id
WHERE u.business_area_name=‘Sales’
);

The retrieved table names and their corresponding ILM objects are then stored in memory for further processing. This retrieval operation may be implemented in ABAP using a mapping class that retrieves table associations for the identified ILM objects. This retrieval operation may be implemented in ABAP as:
DATA(lo_table_mapper)=NEW zcl_table_mapper( ).
DATA(lt_table_list)=lo_table_mapper->get_tables_for_ilmo(EXPORTING it_ilmo_objects=lt_ilmo_objects).

With the set of relevant tables identified, the system proceeds to determine whether memory footprint data for the ILM objects has already been computed and stored in a snapshot. The system is designed to track memory growth statistics over an 18-month period by default, although this value may be configurable in the Provider_Config table 538. The snapshot retrieval process involves querying I_MemorySnapshot 532 and I_LatestSnapshot 540 to check for existing memory usage records within the past 18 months. The system first determines whether a valid snapshot exists by executing:
SELECT snapshot_id, snapshot_timestamp
FROM I_LatestSnapshot
WHERE ilmo_object_id IN (SELECT ilmo_object_id FROM ILM_Table_Map)
AND snapshot_timestamp>CURRENT_TIMESTAMP-INTERVAL ‘18 MONTHS’
ORDER BY snapshot_timestamp DESC
LIMIT 1;

If a valid snapshot is found, the system retrieves the precomputed memory footprint from a C_AnalyzedMemory 214. To retrieve precomputed memory footprints, the system executes the following SQL query:
SELECT a.ilmo_object_id, a.total_memory_usage
FROM C_AnalyzedMemory a
WHERE a.snapshot_id=(
SELECT snapshot_id
FROM I_LatestSnapshot
WHERE ilmo_object_id IN (SELECT ilmo_object_id FROM ILM_Table_Map)
AND snapshot_timestamp>CURRENT_TIMESTAMP−INTERVAL ‘18 MONTHS’
ORDER BY snapshot_timestamp DESC
LIMIT 1
);

If no valid snapshot is found, the system computes the memory footprint in real time. This is handled by I_OnDemandMemoryCompute 632, which initiates an on-the-fly retrieval of memory usage statistics from the database. The system retrieves table-level statistics, including record counts and storage footprint data, from the relevant database structures while maintaining consistency with historical trend analysis:
SELECT table_name, total_size_mb, row_count
FROM TableStatisticsAPI
WHERE table_name IN (SELECT table_name FROM ILM_Table_Map)
AND snapshot_timestamp>CURRENT_TIMESTAMP−INTERVAL ‘18 MONTHS’;

Once the memory footprint data has been retrieved, it is processed using a CL_OnDemandMemoryCompute 636, which applies ILM-specific rules and aggregates the total footprint for each ILM object. The computation process is executed within ABAP as:
DATA(lo_memory_compute)=NEW cl_OnDemandMemoryCompute( ).
DATA(lt_memory_usage)=lo_memory_compute-
>compute_memory_footprint(EXPORTING it_table_list=lt_table_list iv_period_months=18).

The computed memory footprint data is then passed to a C_MemoryAggr 624 and a CL_MemoryAggregator 628, which aggregate and format the results for further analysis. The aggregation step is handled using:
DATA(lo_memory_aggr)=NEW CL_MemoryAggregator( ).
DATA(lt_aggregated_memory)=lo_memory_aggr-
>aggregate_memory_data(EXPORTING it_memory_data=lt_memory_usage iv_period_months =18).

To avoid redundant recalculations, the aggregated memory footprint data is persisted into I_MemorySnapshot 532, allowing reuse in future queries rather than requiring real-time computation again. This step is performed with the following SQL INSERT statement:
INSERT INTO I_MemorySnapshot (snapshot_id, ilmo_object_id, total_memory_usage, created_at, calculation_period_months)
VALUES (NEW_SNAPSHOT_ID,:ilmo_object_id, :total_memory_usage, CURRENT_TIMESTAMP, 18);

In ABAP RAP, the equivalent persistency operation is executed as an update to stored snapshot records. The equivalent persistency operation in ABAP RAP is executed as:
lo_memory_aggr->store_aggregated_memory(EXPORTING it_memory_data=lt_aggregated_memory iv_period_months=18).

Once the memory footprint data is finalized, residence policies are applied based on a ResidenceConfig table 554, which specifies how long data should be retained before archiving. The system retrieves the configured residence policies using the following query:
SELECT residence_time_days
FROM ResidenceConfig
WHERE ilmo_object_id IN (SELECT ilmo_object_id FROM ILM_Table_Map);

The residence time is then used to determine which portions of the dataset qualify for archival. The system retrieves the configured residence policies with:
DATA(lo_retention_policy)=NEW zcl_retention_manager( ).
DATA(lt_retention_results)=lo_retention_policy->apply_policies(EXPORTING it_memory_data=lt_aggregated_memory iv_period_months =18) .

The processed memory footprint data, along with residence-adjusted recommendations, is formatted and displayed within the SAP FIORI UI. The presentation layer retrieves data using a RAP-based OData provider, which supplies structured memory usage statistics for display. The UI presents this information using graphical elements such as bar charts, delta indicators, and tabular views, allowing users to analyze total memory usage, analyzed memory, and historical growth trends. UI settings, including display preferences, filtering criteria, and user-role-based access, are managed through configurable parameters that define how data is structured and presented to end users. The final results are retrieved with:
SELECT UI_element, display_order, filter_criteria
FROM UserInterfaceConfig
WHERE user_role=‘Administrator’;

The UI components are populated using formatting logic that structures the data for presentation based on user roles and configured display settings, such as:
DATA(lo_ui_formatter)=NEW zcl_ui_formatter( ).
lo_ui_formatter->display_memory_usage(EXPORTING it_final_data=lt_retention_results iv_period_months=18).

By integrating user-configurable inputs, dynamic table selection, snapshot-based retrieval, and real-time computation where necessary, the system provides a flexible and efficient approach to ILM object memory footprint analysis while maintaining an 18-month default tracking period, which may be configured based on system settings or user selection.

### Example 9—Example Operations

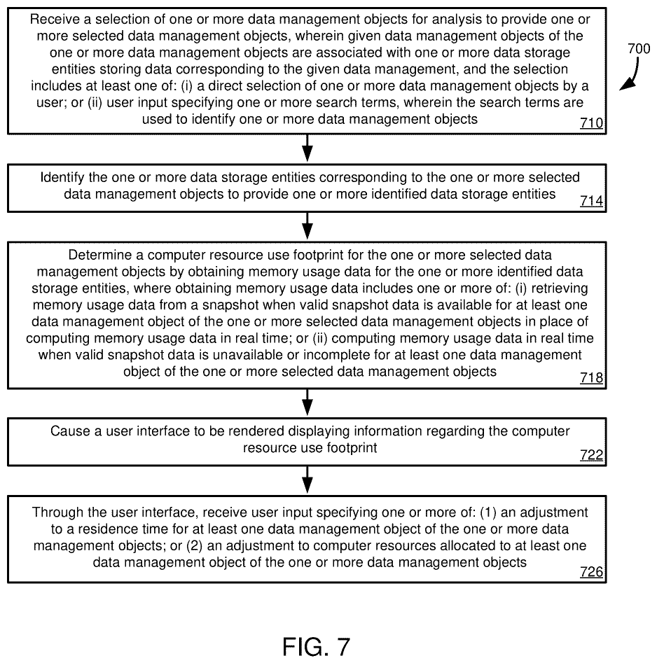

FIG. 7 provides a flowchart of a process 700 for analyzing computer resource usage for selected data management objects.

At 710, a selection of one or more data management objects is received for analysis, resulting in one or more selected data management objects. These selected data management objects are associated with one or more data storage entities that store data corresponding to the selected data management objects. The selection includes at least one of a direct selection of one or more data management objects by a user or user input specifying one or more search terms, where the search terms are used to identify one or more data management objects.

Following selection, at 714, the one or more data storage entities corresponding to the one or more selected data management objects are identified to provide one or more identified data storage entities. At 718, a computer resource use footprint is determined for the one or more selected data management objects by obtaining memory usage data for the one or more identified data storage entities. Obtaining memory usage data includes one or more of retrieving memory usage data from a snapshot when valid snapshot data is available for at least one data management object of the one or more selected data management objects or computing memory usage data in real time when valid snapshot data is unavailable or incomplete for at least one data management object of the one or more selected data management objects.

A user interface is caused to be rendered at 722 to display information regarding the computer resource use footprint. Through the user interface, user input is received at 726 specifying one or more of an adjustment to a residence time for at least one data management object of the one or more data management objects or an adjustment to computer resources allocated to at least one data management object of the one or more data management objects.

### Example 10—Additional Examples

Example 1 is a computing system that includes at least one memory, one or more hardware processor units coupled to the at least one memory, and one or more computer-readable storage media storing computer-executable instructions. The instructions, when executed, cause the computing system to perform operations including receiving a selection of one or more data management objects for analysis to provide one or more selected data management objects. The selected data management objects are associated with one or more data storage entities storing data corresponding to the given data management objects. The selection includes at least one of a direct selection of one or more data management objects by a user or user input specifying one or more search terms, where the search terms are used to identify one or more data management objects.

The operations include identifying the one or more data storage entities corresponding to the one or more selected data management objects to provide one or more identified data storage entities. A computer resource use footprint for the one or more selected data management objects is determined by obtaining memory usage data for the one or more identified data storage entities. The memory usage data is obtained by either retrieving memory usage data from a snapshot when valid snapshot data is available for at least one data management object of the one or more selected data management objects or computing memory usage data in real time when valid snapshot data is unavailable or incomplete for at least one data management object of the one or more selected data management objects.

A user interface is caused to be rendered to display information regarding the computer resource use footprint. Through the user interface, user input is received specifying one or more of an adjustment to a residence time for at least one data management object or an adjustment to computer resources allocated to at least one data management object.

Example 2 is the computing system of Example 1, where the user input specifies one or more search terms usable to identify a business area, and where the search terms are used to identify one or more data management objects associated with the business area.

Example 3 is the computing system of Example 2, where identifying the one or more data management objects associated with the business area includes querying a structured mapping that links business areas to data management objects.

Example 4 is the computing system of any of Examples 1-3, where computing memory usage data in real time includes retrieving record count and data storage entity size statistics from a storage system and computing an estimated memory footprint based on the record count and data storage entity size statistics.

Example 5 is the computing system of any of Examples 1-4, where retrieving memory usage data from a snapshot includes selecting a most recent valid snapshot from a plurality of stored snapshots based on a predefined time interval.

Example 6 is the computing system of any of Examples 1-5, where the adjustment to the residence time for at least one data management object includes modifying a configured residence time associated with the at least one data management object.

Example 7 is the computing system of Example 6, where modifying the configured residence time causes a migration of data associated with the at least one data management object from memory to persistent storage.

Example 8 is the computing system of any of Examples 1-7, where the adjustment to computer resources allocated to at least one data management object includes increasing a memory allocation for the data management object.

Example 9 is the computing system of any of Examples 1-8, where the one or more data management objects abstract underlying data storage entities.

Example 10 is the computing system of any of Examples 1-9, where at least some of the one or more data storage entities are database tables or database views.

Example 11 is the computing system of Examples 1-10, where obtaining memory usage data includes computing memory usage data in real time when valid snapshot data is unavailable or incomplete for at least one data management object of the one or more selected data management objects.

Example 12 is a method implemented in a computing system that includes at least one hardware processor and at least one memory coupled to the at least one hardware processor. The method includes receiving a selection of one or more data management objects for analysis to provide one or more selected data management objects, where given data management objects of the one or more data management objects are associated with one or more data storage entities storing data corresponding to the given data management objects. The selection includes at least one of a direct selection of one or more data management objects by a user or user input specifying one or more search terms, where the search terms are used to identify one or more data management objects.

The method includes identifying the one or more data storage entities corresponding to the one or more selected data management objects to provide one or more identified data storage entities. A computer resource use footprint for the one or more selected data management objects is determined by obtaining memory usage data for the one or more identified data storage entities. Obtaining memory usage data includes computing memory usage data in real time when valid snapshot data is unavailable or incomplete for at least one data management object of the one or more selected data management objects.

A user interface is caused to be rendered to display information regarding the computer resource use footprint. Through the user interface, user input is received specifying one or more of an adjustment to a residence time for at least one data management object or an adjustment to computer resources allocated to at least one data management object.

Example 13 is the method of Example 12, where computing memory usage data in real time includes retrieving record count and data storage entity size statistics from a storage system and computing an estimated memory footprint based on the record count and data storage entity size statistics.

Example 14 is the method of Example 12 or Example 13, where the adjustment to the residence time for at least one data management object includes modifying a configured residence time associated with the at least one data management object.

Example 15 is the method of Example 14, where modifying the configured residence time causes a migration of data associated with the at least one data management object from memory to persistent storage.

Example 16 is the method of any of Examples 12-15, where the adjustment to computer resources allocated to at least one data management object includes increasing a memory allocation for the data management object.

Example 17 is one or more non-transitory computer-readable storage media including computer-executable instructions that, when executed by a computing system that includes at least one hardware processor and at least one memory coupled to the at least one hardware processor, cause the computing system to perform operations including receiving a selection of one or more data management objects for analysis to provide one or more selected data management objects. The selected data management objects are associated with one or more data storage entities storing data corresponding to the given data management objects. The selection includes at least one of a direct selection of one or more data management objects by a user or user input specifying one or more search terms, where the search terms are used to identify one or more data management objects.

The operations include identifying the one or more data storage entities corresponding to the one or more selected data management objects to provide one or more identified data storage entities. A computer resource use footprint for the one or more selected data management objects is determined by obtaining memory usage data for the one or more identified data storage entities. The memory usage data is obtained by either retrieving memory usage data from a snapshot when valid snapshot data is available for at least one data management object of the one or more selected data management objects or computing memory usage data in real time when valid snapshot data is unavailable or incomplete for at least one data management object of the one or more selected data management objects.

A user interface is caused to be rendered to display information regarding the computer resource use footprint. Through the user interface, user input is received specifying one or more of an adjustment to a residence time for at least one data management object or an adjustment to computer resources allocated to at least one data management object.

Example 18 is the one or more computer-readable storage media of Example 17, where computing memory usage data in real time includes retrieving record count and data storage entity size statistics from a storage system and computing an estimated memory footprint based on the record count and data storage entity size statistics.

Example 19 is the one or more computer-readable storage media of Example 17 or Example 18, where the adjustment to the residence time for at least one data management object includes modifying a configured residence time associated with the at least one data management object.

Example 20 is the one or more computer-readable storage media of any of Examples 17-19, where the adjustment to computer resources allocated to at least one data management object includes increasing a memory allocation for the data management object.

### Example 11—Computing Systems

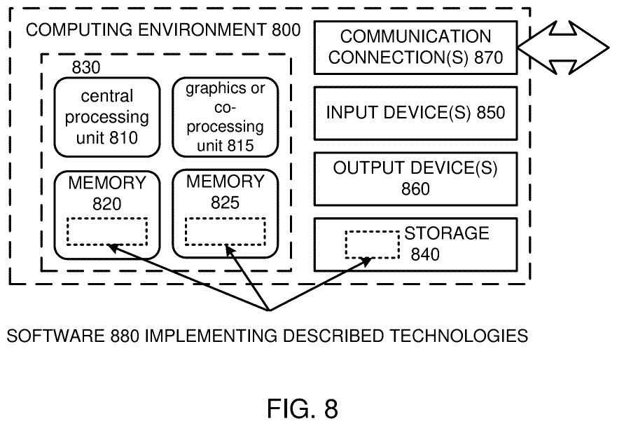

FIG. 8 depicts a generalized example of a suitable computing system 800 in which the described innovations may be implemented. The computing system 800 is not intended to suggest any limitation as to scope of use or functionality of the present disclosure, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions, such as for implementing a database environment, and associated methods, described in Examples 1-10. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s) 810, 815. The memory 820, 825 stores software 880 implementing one or more innovations described herein, in the form of computer-executable instructions suitable for execution by the processing unit(s) 810, 815.

A computing system 800 may have additional features. For example, the computing system 800 includes storage 840, one or more input devices 850, one or more output devices 860, and one or more communication connections 870. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 may be removable or non-removable, and includes magnetic disks, magnetic tapes or cassettes, CD-ROMs, DVDs, or any other medium which can be used to store information in a non-transitory way, and which can be accessed within the computing system 800. The storage 840 stores instructions for the software 880 implementing one or more innovations described herein.

The input device(s) 850 may be a touch input device such as a keyboard, mouse, pen, or trackball, a voice input device, a scanning device, or another device that provides input to the computing system 800. The output device(s) 860 may be a display, printer, speaker, CD-writer, or another device that provides output from the computing system 800.

The communication connection(s) 870 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 12—Cloud Computing Environment

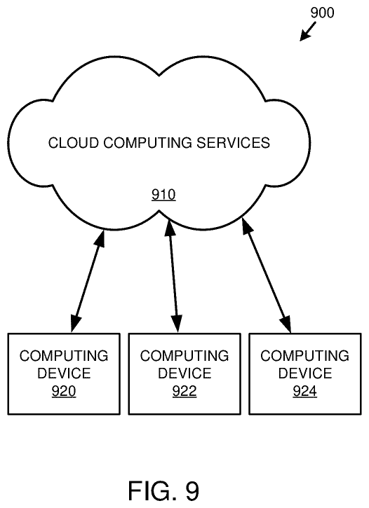

FIG. 9 depicts an example cloud computing environment 900 in which the described technologies can be implemented. The cloud computing environment 900 comprises cloud computing services 910. The cloud computing services 910 can comprise various types of cloud computing resources, such as computer servers, data storage repositories, networking resources, etc. The cloud computing services 910 can be centrally located (e.g., provided by a data center of a business or organization) or distributed (e.g., provided by various computing resources located at different locations, such as different data centers and/or located in different cities or countries).
The cloud computing services 910 are utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operators (e.g., data processing, data storage, and the like).

### Example 13—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 8, computer-readable storage media include memory 820 and 825, and storage 840. The term computer-readable storage media does not include signals and carrier waves. In addition, the term computer-readable storage media does not include communication connections (e.g., 870).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving a selection of one or more data management objects for analysis to provide one or more selected data management objects, wherein given data management objects of the one or more data management objects are associated with one or more data storage entities storing data corresponding to the given data management, and the selection comprises at least one of:
(i) a direct selection of one or more data management objects by a user; or
(ii) user input specifying one or more search terms, wherein the search terms are used to identify one or more data management objects;
identifying the one or more data storage entities corresponding to the one or more selected data management objects to provide one or more identified data storage entities;
determining a computer resource use footprint for the one or more selected data management objects by obtaining memory usage data for the one or more identified data storage entities, wherein obtaining memory usage data comprises one or more of:
(i) retrieving memory usage data from a snapshot when valid snapshot data is available for at least one data management object of the one or more selected data management objects in place of computing memory usage data in real time; or
(ii) computing memory usage data in real time when valid snapshot data is unavailable or incomplete for at least one data management object of the one or more selected data management objects;
causing a user interface to be rendered displaying information regarding the computer resource use footprint;
through the user interface, receiving user input specifying one or more of:
(1) an adjustment to a residence time for at least one data management object of the one or more data management objects; or
(2) an adjustment to computer resources allocated to at least one data management object of the one or more data management objects.

2. The computing system of claim 1, wherein the user input specifies one or more search terms useable to identify a business area, and wherein the search terms are used to identify one or more data management objects associated with the business area.

3. The computing system of claim 2, wherein identifying the one or more data management objects associated with the business area comprises querying a structured mapping that links business areas to data management objects.

4. The computing system of claim 1, wherein computing memory usage data in real time comprises:
retrieving record count and data storage entity size statistics from a storage system; and
computing an estimated memory footprint based on the record count and data storage entity size statistics.

5. The computing system of claim 1, wherein retrieving memory usage data from a snapshot comprises selecting a most recent valid snapshot from a plurality of stored snapshots based on a predefined time interval.

6. The computing system of claim 1, wherein the adjustment to the residence time for at least one data management object of the one or more data management objects comprises modifying a configured residence time associated with the at least one data management object.

7. The computing system of claim 6, wherein modifying the configured residence time causes a migration of data associated with the at least one data management object from memory to persistent storage.

8. The computing system of claim 1, wherein the adjustment to computer resources allocated to at least one data management object of the one or more data management objects comprises increasing a memory allocation for the data management object.

9. The computing system of claim 1, wherein the one or more data management objects abstract underlying data storage entities.

10. The computing system of claim 1, wherein at least some of the one or more data storage entities are database tables or database views.

11. The computing system of claim 1, wherein the obtaining memory usage data comprises computing memory usage data in real time when valid snapshot data is unavailable incomplete for at least one data management object of the one or more selected data management objects.

12. A method, implemented in a computing system comprising at least one hardware processor and at least one memory coupled to the at least one hardware processor, the method comprising:
receiving a selection of one or more data management objects for analysis to provide one or more selected data management objects, wherein given data management objects of the one or more data management objects are associated with one or more data storage entities storing data corresponding to the given data management, and the selection comprises at least one of:
(i) a direct selection of one or more data management objects by a user; or
(ii) user input specifying one or more search terms, wherein the search terms are used to identify one or more data management objects;
identifying the one or more data storage entities corresponding to the one or more selected data management objects to provide one or more identified data storage entities;
determining a computer resource use footprint for the one or more selected data management objects by obtaining memory usage data for the one or more identified data storage entities, wherein obtaining memory usage data comprises computing memory usage data in real time when valid snapshot data is unavailable or incomplete for at least one data management object of the one or more selected data management objects;
causing a user interface to be rendered displaying information regarding the computer resource use footprint;
through the user interface, receiving user input specifying one or more of:
(1) an adjustment to a residence time for at least one data management object of the one or more data management objects; or
(2) an adjustment to computer resources allocated to at least one data management object of the one or more data management objects.

13. The method of claim 12, wherein computing memory usage data in real time comprises:
retrieving record count and data storage entity size statistics from a storage system; and
computing an estimated memory footprint based on the record count and data storage entity size statistics.

14. The method of claim 12, wherein the adjustment to the residence time for at least one data management object of the one or more data management objects comprises modifying a configured residence time associated with the at least one data management object.

15. The method of claim 14, wherein modifying the configured residence time causes a migration of data associated with the at least one data management object from memory to persistent storage.

16. The method of claim 12, wherein the adjustment to computer resources allocated to at least one data management object of the one or more data management objects comprises increasing a memory allocation for the data management object.

17. One or more non-transitory computer-readable storage media comprising:
computer-executable instructions that, when executed by a computing system comprising at least one hardware processor and at least one memory coupled to the at least one hardware processor, cause the computing system to receive a selection of one or more data management objects for analysis to provide one or more selected data management objects, wherein given data management objects of the one or more data management objects are associated with one or more data storage entities storing data corresponding to the given data management, and the selection comprises at least one of:
(i) a direct selection of one or more data management objects by a user; or
(ii) user input specifying one or more search terms, wherein the search terms are used to identify one or more data management objects;
computer-executable instructions that, when executed by the computing system, cause the computing system to identify the one or more data storage entities corresponding to the one or more selected data management objects to provide one or more identified data storage entities;
computer-executable instructions that, when executed by the computing system, cause the computing system to determine a computer resource use footprint for the one or more selected data management objects by obtaining memory usage data for the one or more identified data storage entities, wherein obtaining memory usage data comprises one or more of:
(i) retrieving memory usage data from a snapshot when valid snapshot data is available for at least one data management object of the one or more selected data management objects in place of computing memory usage data in real time; or
(ii) computing memory usage data in real time when valid snapshot data is unavailable or incomplete for at least one data management object of the one or more selected data management objects;
computer-executable instructions that, when executed by the computing system, cause the computing system to cause a user interface to be rendered displaying information regarding the computer resource use footprint;
computer-executable instructions that, when executed by the computing system, cause the computing system to, through the user interface, receive user input specifying one or more of:
(1) an adjustment to a residence time for at least one data management object of the one or more data management objects; or
(2) an adjustment to computer resources allocated to at least one data management object of the one or more data management objects.

18. The one or more computer-readable storage media of claim 17, wherein computing memory usage data in real time comprises:
retrieving record count and data storage entity size statistics from a storage system; and
computing an estimated memory footprint based on the record count and data storage entity size statistics.

19. The one or more computer-readable storage media of claim 17, wherein the adjustment to the residence time for at least one data management object of the one or more data management objects comprises modifying a configured residence time associated with the at least one data management object.

20. The one or more computer-readable storage media of claim 17, wherein the adjustment to computer resources allocated to at least one data management object of the one or more data management objects comprises increasing a memory allocation for the data management object.
